(19) United States
(12) Patent Application Publication
(10) Pub. No.: US 2025/0223127 A1
(43) Pub. Date: Jul. 10, 2025

(54) TRANSFER TOOL

(71) Applicant: KOKUYO CO., LTD., Osaka-shi, Osaka (JP)

(72) Inventors: Manari Shigeno, Osaka-shi (JP); Hisashi Yamamoto, Osaka-shi (JP); Masahiro Nakamura, Osaka-shi (JP); Hideto Shima, Kyotanabe-shi (JP)

(73) Assignee: KOKUYO CO., LTD., Osaka-shi, Osaka (JP)

(21) Appl. No.: 18/853,803

(22) PCT Filed: Jan. 25, 2023
(86) PCT No.: PCT/JP2023/002211

§ 371 Date: Oct. 3, 2024

(30) Foreign Application Priority Data
Apr. 13, 2022 (JP) 2022-066256

(51) Int. Cl. B65H 18/10; B65H 27/00

(52) U.S. Cl. CPC B65H 18/103; B65H 27/00; B65H 2301/4146; B65H 2403/20; B65H 2403/40; B65H 2515/30

(57) ABSTRACT

To prevent a support shaft from breaking during production and assembly. A transfer tool of the present invention is a transfer tool that allows a transfer tape fed out from a feed reel to be wound onto a take-up reel via a transfer head, and includes a rotation transmission means having a feed gear, a take-up gear, and an intermediate gear, that have a disc shape, and transmitting rotation of the feed reel to the take-up reel. The intermediate gear is rotatably supported by an intermediate support shaft, and the intermediate gear is provided with a stress relief means that relieves bending stress when the intermediate gear is attached to the intermediate support shaft.

### TECHNICAL FIELD

The present invention relates to a transfer tool.

### BACKGROUND ART

In the related art, various transfer tools are known in which a transfer tape to which a transfer object such as a correction tape material or glue is attached is pressed against a transfer target surface by a transfer head to transfer the transfer object to the transfer target surface.

As the transfer tool, there is a coating film transfer tool in which a supply reel around which a transfer tape is wound, a transfer head that transfers the transfer tape pulled out from the supply reel to a transfer target portion, and a take-up reel that takes up the transfer tape after the transfer are disposed (see Patent Document 1). In the coating film transfer tool of Patent Document 1, a supply reel gear that rotates together with the supply reel is rotatably attached to a supply reel support shaft, and a take-up reel gear that rotates together with the take-up reel is rotatably attached to a take-up reel support shaft. A transmission gear is provided between the supply reel gear and the take-up reel support shaft, and when the take-up reel is attached to the take-up reel support shaft, the supply reel gear, the transmission gear, and the take-up reel gear mesh with each other.

### PRIOR ART DOCUMENT

### Patent Document

Patent Document 1: Japanese Unexamined Patent Application Publication No. 2020-90043

### SUMMARY OF THE INVENTION

### Technical Problem

In a transfer tool similar to the coating film transfer tool of Patent Document 1, for example, the supply reel support shaft may include a first shaft portion and a second shaft portion which are divided in the vertical direction, and locking portions may be formed on the outer peripheral surfaces of the tip portions of the first shaft portion and the second shaft portion. In this case, in a case where the supply reel gear is attached to the supply reel support shaft, when the locking portion of the first shaft portion and the locking portion of the second shaft portion pass through the shaft hole of the supply reel gear, the first shaft portion and the second shaft portion are bent in such a manner that the locking portion of the first shaft portion and the locking portion of the second shaft portion approach each other. Thereafter, the locking portion of the first shaft portion and the locking portion of the second shaft portion, that have passed through the shaft hole of the supply reel gear, return to a separated state, whereby the supply reel gear is attached to the supply reel support shaft so as to be prevented from coming off. At this time, when the supply reel gear is mounted, a bending stress is concentrated on the root portion of the supply reel support shaft, and therefore, there is a problem that the support shaft is broken during production and assembly.

For example, in the case of the coating film transfer tool of Patent Document 1, the above-described problem may occur not only in the supply reel gear but also in the case where the take-up reel gear or the transmission gear is attached to the support shaft. Further, in a transfer tool that transmits the rotation of a feed reel to a take-up reel via a pulley and a belt, the same problem may occur when the pulley is attached to a support shaft.

The present invention has been made in view of these problems, and it is an object of the present invention to provide a transfer tool capable of preventing a support shaft from breaking during production and assembly.

### Solution to the Problem

The present invention adopts the following means to achieve such an object.

That is, a transfer tool of the present invention is a transfer tool that allows a transfer tape fed out from a feed reel to be wound onto a take-up reel via a transfer head, and includes a rotation transmission means having a plurality of rotation transmission members that have a disc shape and transmitting rotation of the feed reel to the take-up reel. Each rotation transmission member is rotatably supported by a support shaft, and at least one rotation transmission member of the plurality of rotation transmission members is provided with a stress relief means that relieves bending stress when the rotation transmission member is attached to the support shaft.

With this configuration, when the rotation transmission member is attached to the support shaft, the bending stress acting on the support shaft is relieved by the stress relief means, and thus the bending stress is not concentrated on the root portion of the support shaft. Therefore, it is possible to prevent the support shaft from breaking during production and assembly. As a result, the defective rate can be reduced.

In the transfer tool of the present invention, it is preferable that the support shaft have a plurality of shaft portions divided in a circumferential direction, and that the stress relief means include an opening provided inside the plurality of shaft portions.

With this configuration, when the rotation transmission member is attached to the support shaft, the root portions of the plurality of shaft portions can move in a direction approaching each other. Therefore, when the rotation transmission member is attached to the support shaft, the bending stress can be appropriately relieved.

In the transfer tool of the present invention, it is preferable that the stress relief means include a first slit opening, a second slit opening, and a third slit opening, that the support shaft have a first shaft portion and a second shaft portion divided in a circumferential direction, that the first shaft portion be provided in a first support portion disposed between the first slit opening and the second slit opening, and that the second shaft portion be provided in a second support portion disposed between the second slit opening and the third slit opening.

With this configuration, the support shaft to which the rotation transmission member is attached is divided into the first shaft portion and the second shaft portion, and the second slit opening is provided between the root portion of the first shaft portion and the root portion of the second support portion. Therefore, when the rotation transmission member is attached to the support shaft, it is possible to easily form the opening that allows the root portion of the first shaft portion and the root portion of the second support portion to move in a direction approaching each other.

In the transfer tool of the present invention, it is preferable that a first thick portion whose width along the second slit opening is wider than a tip portion of the first shaft portion be formed at a root portion of the first shaft portion, and that a second thick portion whose width along the second slit opening is wider than a tip portion of the second shaft portion be formed at a root portion of the second shaft portion.

With this configuration, the base end of the support shaft can be reinforced by thickening the root portion of the first shaft portion and the root portion of the second shaft portion.

In the transfer tool of the present invention, it is preferable that the first to third slit openings extend substantially parallel to a direction of stress acting on the rotation transmission member via the transfer tape when the transfer tape is used.

With this configuration, when the transfer tool is used by pressing the head at the tip, stresses are applied to the rotation transmission member through the tape, but the stresses can be received by both the first shaft portion and the second shaft portion.

In the transfer tool of the present invention, it is preferable that the rotation transmission means include a feed rotation transmission member rotatably supported by a feed support shaft and integrally rotatable with the feed reel, a take-up rotation transmission member rotatably supported by a take-up support shaft and integrally rotatable with the take-up reel, and an intermediate rotation transmission member rotatably supported by an intermediate support shaft and disposed between the feed rotation transmission member and the take-up rotation transmission member, and that the stress relief means be provided to relieve bending stress when the rotation transmission member is attached to at least a support shaft having a smallest shaft diameter among the feed support shaft, the take-up support shaft, and the intermediate support shaft.

With this configuration, it is possible to prevent the support shaft having the smallest shaft diameter among the feed support shaft, the take-up support shaft, and the intermediate support shaft from breaking during production and assembly.

In the transfer tool of the present invention, it is preferable that the rotation transmission member be a gear.

In the transfer tool of the present invention, it is preferable that the rotation transmission member be a pulley.

### Advantageous Effect of the Invention

According to the present invention, it is possible to prevent the support shaft from breaking when the rotation transmission member is attached to the support shaft during production and assembly.

### BRIEF DESCRIPTION OF THE DRAWINGS

FIG. 1 is a perspective view of a transfer tool 1 according to an embodiment of the present invention. FIG. 2(a) is a front view of the transfer tool 1 of FIG. 1, and FIG. 2(b) is a diagram illustrating a reel interlocking mechanism E.

FIG. 3 is a plan view illustrating a configuration of a first case member 2a included in the transfer tool 1 of FIG. 1.

FIG. 4 is a perspective view illustrating the configuration of the first case member 2a included in the transfer tool 1 of FIG. 1.

FIG. 5(a) is a cross-sectional view taken along a line a1-a1 in FIG. 3, and FIG. 5(b) is a cross-sectional view taken along a line a2-a2 in FIG. 3.

FIG. 6(a) is a plan view of an intermediate gear e2, FIG. 6(b) is a plan view of the periphery of an intermediate support shaft 12, and FIG. 6(c) is a plan view illustrating a state where the intermediate gear e2 is attached to the intermediate support shaft 12.

FIGS. 7(a) to 7(c) are diagrams for explaining the bending action of a first shaft portion 12a and a second shaft portion 12b when the intermediate gear e2 is attached to the intermediate support shaft 12.

FIG. 8 is a front view of a transfer tool 101 according to a variation of the present invention.

FIG. 9 is a front view of a transfer tool 201 according to a variation of the present invention.

FIG. 10 is a front view of a transfer tool 301 according to a variation of the present invention.

FIG. 11 is a plan view illustrating a configuration around an intermediate support shaft 512 of a transfer tool according to a variation of the present invention.

FIG. 12 is a plan view illustrating a configuration around an intermediate support shaft 612 of a transfer tool according to a variation of the present invention.

### DESCRIPTION OF THE EMBODIMENT

Hereinafter, an embodiment of the present invention will be described with reference to the drawings.

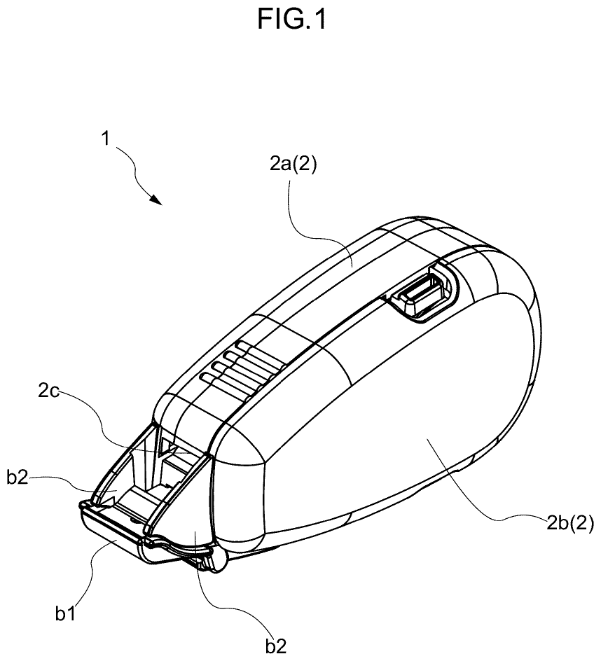

FIG. 1 is a perspective view of a transfer tool 1 according to an embodiment of the present invention. FIG. 2 is a front view of the transfer tool 1 of FIG. 1. FIG. 2 illustrates a state where a second case member 2b constituting a case 2 is removed in order to facilitate the description of the main parts inside the case 2.

In the present embodiment, the present invention is applied to a transfer tool for transferring a correction tape material T, which is a transfer object, to a transfer target surface such as a sheet of paper.

As illustrated in FIGS. 1 and 2, the transfer tool 1 of the present embodiment has the case 2 capable of housing a feed reel A around which a transfer tape T is wound, a take-up reel C, and a reel interlocking mechanism E. A transfer head B is disposed at a front end portion of the case 2. In the transfer tool 1, the transfer tape T fed out from the feed reel A is wound around the take-up reel C via the transfer head B.

### Case 2

The case 2 is made of a synthetic resin and can form a housing space therein. The case 2 has a first case member side 2a having a right side wall of the transfer tool 1 and a second case member side 2b having a left side wall of the transfer tool 1. By combining the first case member 2a and the second case member 2b, the case 2 is configured in which a housing space capable of housing the feed reel A, the take-up reel C, and the like is formed.

An opening portion 2c for guiding the transfer tape T to the transfer head B and introducing the transfer tape T passed through the transfer head B into the case 2 is formed on the front side of the case 2.

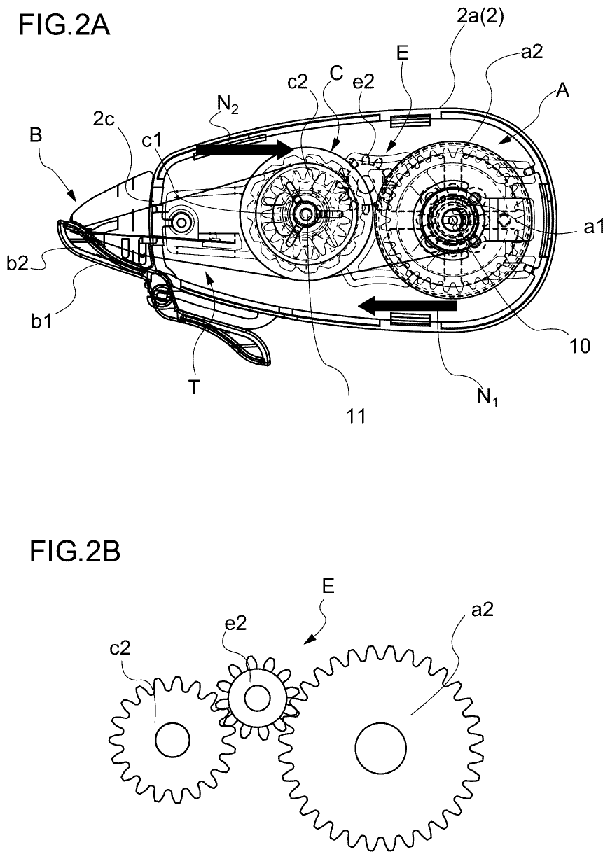

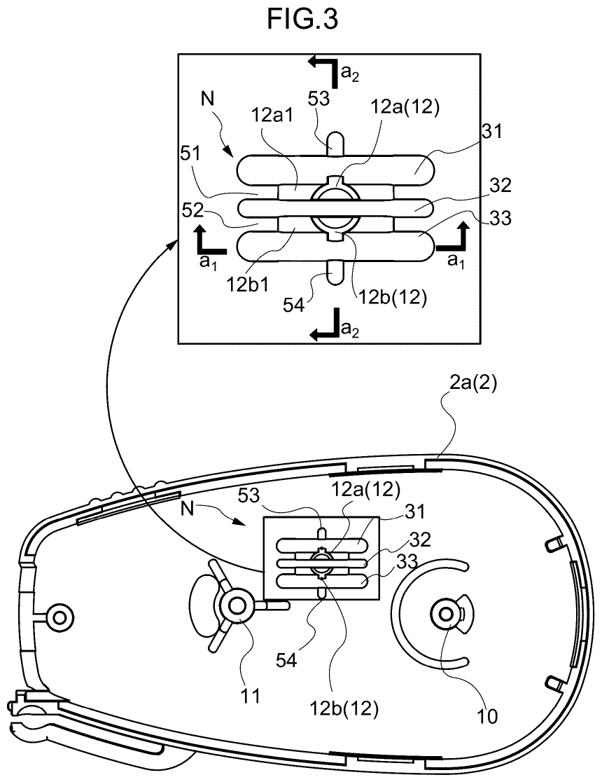

On the inner surface of the first case member 2a, as illustrated in FIG. 3, a feed support shaft 10 that rotatably supports the feed reel A, a take-up support shaft 11 that rotatably supports the take-up reel C, and an intermediate support shaft 12 that rotatably supports an intermediate gear e2 (to be described below) are provided in a protruding manner. In addition to the feed reel A, the take-up reel C, and the reel interlocking mechanism E, other mechanisms such as a clutch mechanism capable of allowing the normal rotation of the feed reel A during the transfer operation are provided inside the case 2. However, in the following explanation, the feed reel A, the take-up reel C, and the reel interlocking mechanism E, which are mainly related to the present invention, will be explained, and the explanation of other mechanisms will be omitted.

### Feed Reel A

The feed reel A has a cylindrical feed reel body portion al extending in the left-right direction on which the transfer tape T is wound. The transfer tape T is wound around the outer periphery of the feed reel body portion a1.

### Transfer Head B

The transfer head B includes a tip pressing portion b1 which is a plate-shaped tip portion for pressing the transfer tape T against a transfer target surface, and left and right guide walls b2 disposed so as to be positioned on the left and right sides of the transfer tape T. The tip pressing portion b1 is brought into contact with the back surface side of the transfer tape T, and can press the transfer tape T against the transfer target surface by the operation of a user. The tip pressing portion b1 has a curved outer surface in a side view.

### Take-up Reel C

The take-up reel C takes up the transfer tape T fed from the feed reel A via the transfer head B. The take-up reel C has a cylindrical take-up reel body portion c1 capable of taking up the transfer tape T, and a take-up gear c2 that is provided integrally with the take-up reel body portion c1 so as to have the same axial center as the take-up reel body portion c1.

### Reel Interlocking Mechanism E

The reel interlocking mechanism E is a rotation transmission means that transmits the rotation of the feed reel A to the take-up reel C. The reel interlocking mechanism E has a feed gear a2 rotatably supported by the feed support shaft 10 of the feed reel A and integrally rotatable with the feed reel A, a take-up gear c2 rotatably supported by the take-up support shaft 11 and provided integrally with the take-up reel C, and the intermediate gear e2 supported by the intermediate support shaft 12, interposed between the feed gear a2 and the take-up gear c2 to mesh with the feed gear a2 and the take-up gear c2.

The feed gear a2 has a disc shape in which a plurality of teeth meshing with the intermediate gear e2 are provided on the outer peripheral edge. The feed gear a2 is rotatably supported by the feed support shaft 10 together with the feed reel A. A sliding mechanism is provided between the feed reel C and the feed gear a2 to allow relative rotation between the feed reel C and the feed gear a2 when a torque of a certain level or greater is applied.

The take-up gear c2 is disposed on the outer surface side of the take-up reel C, and has a disc shape in which a plurality of teeth meshing with the intermediate gear e2 are provided on the outer peripheral edge. The take-up gear c2 is provided integrally with the take-up reel C so as to have the same axial center as the take-up reel C.

The intermediate gear e2 is rotatably supported by the intermediate support shaft 12 provided on the first case member 2a in the state of being prevented from coming off. The intermediate gear e2 has a disc shape in which a plurality of teeth meshing with the feed gear a2 and the take-up gear c2 are provided on the outer peripheral edge. In the present embodiment, regarding the sizes of the feed gear a2, the take-up gear c2, and the intermediate gear e2, the feed gear a2 has the largest radius, and the intermediate gear e2 has the smallest radius. Therefore, regarding the shaft diameters of the feed support shaft 10, the take-up support shaft 11, and the intermediate support shaft 12, the shaft diameter of the intermediate support shaft 12 is the smallest. In the present embodiment, since the strength of the intermediate support shaft 12 is the lowest, a stress relief means N is provided in the vicinity of the root portion of the intermediate support shaft 12.

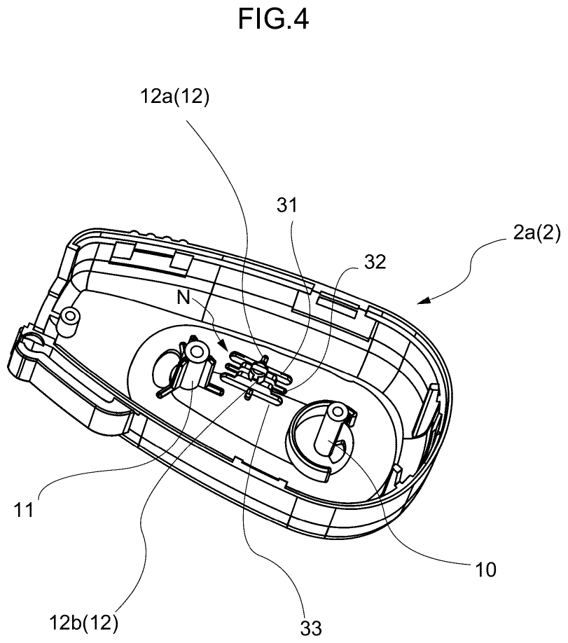

As illustrated in FIGS. 3 and 4, in the first case member 2a, a first slit opening 31, a second slit opening 32, and a third slit opening 33 are formed in order in the vicinity of the root portion of the intermediate support shaft 12 to which the intermediate gear e2 is attached. The first slit opening 31 is disposed at the uppermost position, the third slit opening 33 is disposed at the lowermost position, and the second slit opening 32 is disposed between the first slit opening 31 and the third slit opening 33.

In FIG. 3, the first slit opening 31, the second slit opening 32, and the third slit opening 33 are disposed substantially in parallel. The first slit opening 31, the second slit opening 32, and the third slit opening 33 extend substantially parallel to the direction of the stress acting on the intermediate gear e2 via the transfer tape T when the transfer tape T is used. That is, as illustrated in FIG. 2(a), a force N1 is applied to the feed gear a2 in the direction of pulling same to the left due to the tension of the transfer tape T, and a force N2 is applied to the take-up gear c2 in the direction of pulling same to the right due to the tension of the transfer tape T. Therefore, force acts on the intermediate gear e2 between the feed gear a2 and the take-up gear c2 in a direction in which the intermediate gear e2 is sandwiched along the left-right direction. Thus, the first slit opening 31, the second slit opening 32, and the third slit opening 33 extend along the direction of the forces acting on the intermediate gear e2 (the left-right direction). Although the direction of the tension on the transfer tape T changes slightly depending on the remaining amount of the tape, the first slit opening 31, the second slit opening 32, and the third slit opening 33 extend substantially parallel to the direction of the stress acting on the intermediate gear e2, and maintain the state such that the first shaft portion 12a and the second shaft portion 12b receive the stress acting on the intermediate gear e2. That is, the range of “substantially” in “the first slit opening 31, the second slit opening 32, and the third slit opening 33 extend substantially parallel to the direction of the stress acting on the intermediate gear e2” is the range due to the change in the tape remaining amount. In the present embodiment, the first slit opening 31, the second slit opening 32, and the third slit opening 33 are included in the stress relief means N.

The intermediate support shaft 12 has the first shaft portion 12a and the second shaft portion 12b which are divided in the circumferential direction. To be specific, the first shaft portion 12a is disposed above, and the second shaft portion 12b is disposed below the first shaft portion 12a, and they are spaced apart from each other in the up-down direction. The first shaft portion 12a is provided in a first support portion 51 disposed between the first slit opening 31 and the second slit opening 32. The second shaft portion 12b is provided in a second support portion 52 disposed between the second slit opening 32 and the third slit opening 33.

A first thick portion 12a1 whose width along the second slit opening 32 is wider than the tip portion of the first shaft portion 12a is formed at the root portion of the first shaft portion 12a. The tip portion of the first shaft portion 12a is disposed at the central portion in the longitudinal direction of the first thick portion 12a1. Similarly, a second thick portion 12b1 whose width along the second slit opening 32 is wider than the tip portion of the second shaft portion 12b is formed at the root portion of the second shaft portion 12b. The tip portion of the second shaft portion 12b is disposed at the central portion in the longitudinal direction of the second thick portion 12b1.

On the inner surface of the first case member 2a, a protruding portion 53 is formed above the first slit opening 31, and a protruding portion 54 is formed below the third slit opening 33. The protrusion amount of the protruding portion 53 and the protrusion amount of the protruding portion 54 are substantially the same as the protrusion amount of the first thick portion 12a1 of the first shaft portion 12a and the protrusion amount of the second thick portion 12b1 of the second shaft portion 12b. Therefore, the lower surface of the intermediate gear e2 attached to the intermediate support shaft 12 is placed on the upper surfaces of the protruding portion 53, the protruding portion 54, the first thick portion 12a1 of the first shaft portion 12a, and the second thick portion 12b1 of the second shaft portion 12b, whereby the intermediate gear e2 is disposed at an appropriate height position.

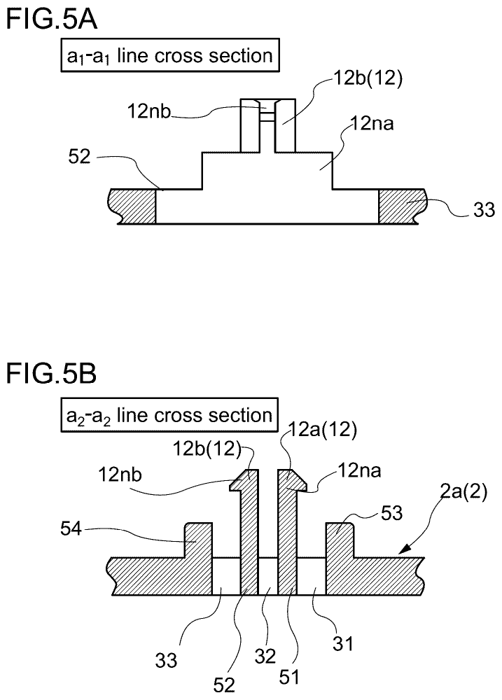

As illustrated in FIGS. 5(a) and 5(b), a locking portion 12na that is locked to the upper surface of the intermediate gear e2 when the intermediate gear e2 is attached is formed so as to protrude on the outer side of the tip portion of the first shaft portion 12a. Similarly, a locking portion 12nb that is locked to the upper surface of the intermediate gear e2 when the intermediate gear e2 is attached is formed so as to protrude on the outer side of the tip portion of the second shaft portion 12b. The protrusion amount of the locking portion 12na and the protrusion amount of the locking portion 12nb increase from the tip toward the root.

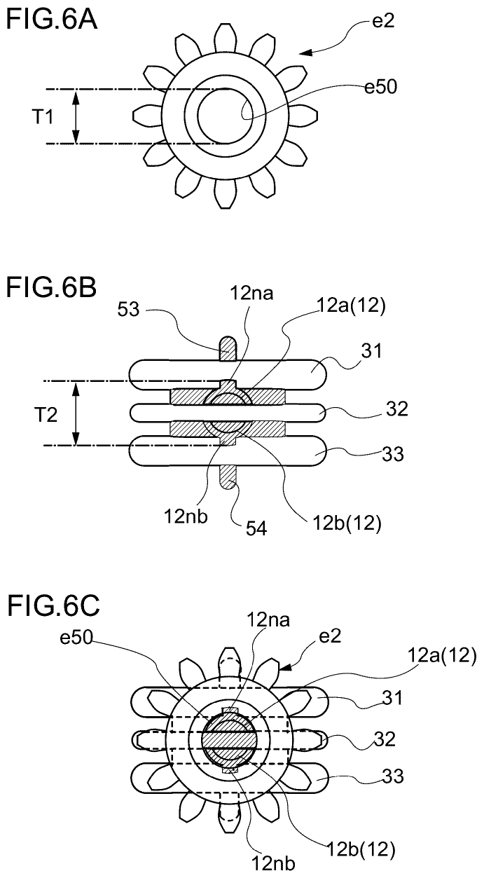

As illustrated in FIG. 6(a), a circular shaft hole e50 is formed at the center of the intermediate gear e2. When the intermediate gear e2 is attached to the intermediate support shaft 12, the first shaft portion 12a and the second shaft portion 12b of the intermediate support shaft 12 are inserted into the shaft hole e50 of the intermediate gear e2. The diameter of the shaft hole e50 of the intermediate gear e2 is T1.

On the other hand, as illustrated in FIG. 6(b), the distance between the lowermost portion (most protruded portion) of the locking portion 12na of the first shaft portion 12a and the lowermost portion (most protruded portion) of the locking portion 12nb of the second shaft portion 12b is T2, which is larger than a radius Tl of the shaft hole e50 of the intermediate gear e2.

Therefore, in the case where the intermediate gear e2 is attached to the intermediate support shaft 12, when the first shaft portion 12a and the second shaft portion 12b of the intermediate support shaft 12 pass through the shaft hole e50 of the intermediate gear e2, the first shaft portion 12a and the second shaft portion 12b bend so as to approach each other, and then the first shaft portion 12a and the second shaft portion 12b bend so as to separate from each other and return to their original positions. Then, as illustrated in FIG. 6(c), the locking portion 12na of the first shaft portion 12a and the locking portion 12nb of the second shaft portion 12b are locked to the upper surface of the intermediate gear e2, and the attachment of the intermediate gear e2 to the intermediate support shaft 12 is completed.

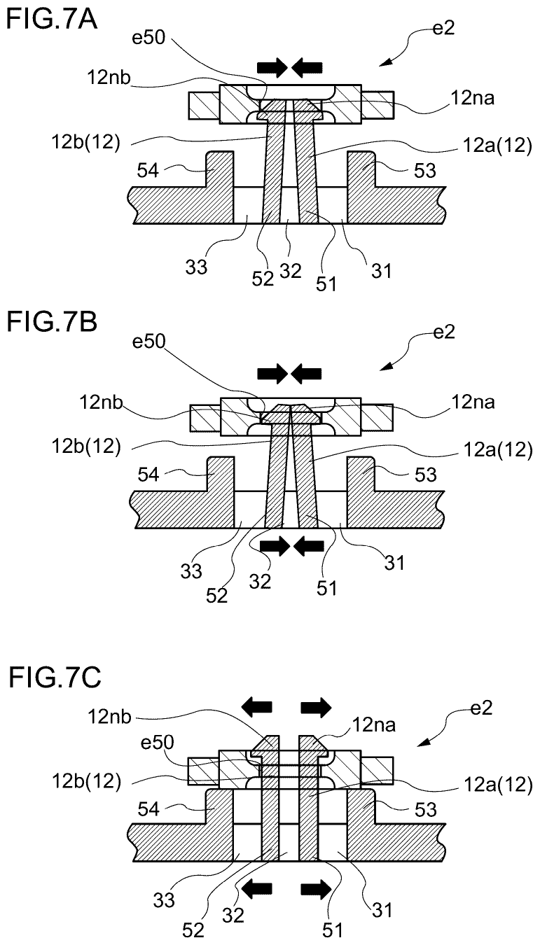

The bending action of the first shaft portion 12a and the second shaft portion 12b when the intermediate gear e2 is attached to the intermediate support shaft 12 will be described in detail with reference to FIG. 7.

When the intermediate gear e2 is attached to the intermediate support shaft 12, the intermediate gear e2 is moved toward the root portion of the intermediate support shaft 12 in such a manner that the first shaft portion 12a and the second shaft portion 12b of the intermediate support shaft 12 are inserted into the shaft hole e50 of the intermediate gear e2. Then, as illustrated in FIG. 7(a), first, the locking portion 12na of the first shaft portion 12a and the locking portion 12nb of the second shaft portion 12b are pressed by the inner peripheral surface of the shaft hole e50 of the intermediate gear e2, and the tip portion of the first shaft portion 12a and the tip portion of the second shaft portion 12b move so as to approach each other.

Thereafter, when the intermediate gear e2 is further moved toward the root portion of the intermediate support shaft 12, as illustrated in FIG. 7(b), the locking portion 12na of the first shaft portion 12a and the locking portion 12nb of the second shaft portion 12b are pressed by the inner peripheral surface of the shaft hole e50 of the intermediate gear e2, and the tip portion of the first shaft portion 12a and the tip portion of the second shaft portion 12b move closer to each other. At this time, the root portion of the first shaft portion 12a and the root portion of the second shaft portion 12b also move so as to approach each other.

Thereafter, when the entire locking portion 12na of the first shaft portion 12a and the entire locking portion 12nb of the second shaft portion 12bpass through the shaft hole e50 of the intermediate gear e2, as illustrated in FIG. 6(c), the locking portion 12na of the first shaft portion 12a and the locking portion 12nb of the second shaft portion 12b are no longer pressed by the inner peripheral surface of the shaft hole e50 of the intermediate gear e2. As a result, the tip portion of the first shaft portion 12a and the tip portion of the second shaft portion 12b move away from each other and return to their original positions. Then, the upper surface of the intermediate gear e2 is locked by the lowermost portion of the locking portion 12na of the first shaft portion 12a and the lowermost portion of the locking portion 12nb of the second shaft portion 12b, and the attachment of the intermediate gear e2 to the support shaft 12 is completed.

As described above, a transfer tool 1 of the present embodiment is a transfer tool that allows a transfer tape T fed out from a feed reel A to be wound onto a take-up reel C via a transfer head B, and includes a rotation transmission means E having a feed gear a2, a take-up gear c2, and an intermediate gear e2 (rotation transmission members), that have a disc shape, and transmitting rotation of the feed reel A to the take-up reel C. The intermediate gear e2 is rotatably supported by an intermediate support shaft 12, and the intermediate gear e2 is provided with a stress relief means N that relieves bending stress when the intermediate gear e2 is attached to the intermediate support shaft 12.

With this configuration, since the bending stress acting when the intermediate gear e2 is attached is relieved by the stress relief means N, the bending stress is dispersed when the gear is attached and is not concentrated on the root portion of the intermediate support shaft 12. Therefore, it is possible to prevent the intermediate support shaft 12 from breaking during production and assembly. As a result, the defective rate can be reduced.

In the transfer tool of the present embodiment, the intermediate support shaft 12 to which the intermediate gear e2 is attached has a first shaft portion 12a and a second shaft portion 12b which are divided in the circumferential direction, and the stress relief means N includes a slit opening 32 provided inside the first shaft portion 12a and the second shaft portion 12b.

With this configuration, when the intermediate gear e2 is attached to the intermediate support shaft 12, the root portions of the first shaft portion 12a and the second shaft portion 12b can move in a direction approaching each other. Therefore, when the intermediate gear e2 is attached, bending stresses can be appropriately relieved.

In the transfer tool of the present embodiment, the stress relief means N includes a first slit opening 31, a second slit opening 32 and a third slit opening 33 formed in order in the vicinity of a lower end portion of the intermediate support shaft 12 that rotatably supports the intermediate gear e2, the intermediate support shaft 12 to which the intermediate gear e2 is attached has a first shaft portion 12a and a second shaft portion 12b divided in a circumferential direction, the first shaft portion 12a is provided in a first support portion 51 disposed between the first slit opening 31 and the second slit opening 32, and the second shaft portion 12b is provided in a second support portion 52 disposed between the second slit opening 32 and the third slit opening 33.

With this configuration, the intermediate support shaft 12 to which the intermediate gear e2 is attached is divided in two, into the first shaft portion 12a and the second shaft portion 12b, and the second slit opening 32 is provided between the root portion of the first shaft portion 12a and the root portion of the second support portion 12b. Therefore, when the intermediate gear e2 is attached to the intermediate support shaft 12, the root portion of the first shaft portion 12a and the root portion of the second support portion 12b can move in a direction approaching each other. Therefore, when the intermediate gear e2 is attached, bending stresses can be appropriately relieved.

In the transfer tool of the present embodiment, a first thick portion 12a1 whose width along the second slit opening 32 is wider than the tip portion of the first shaft portion 12a is formed at the root portion of the first shaft portion 12a, and a second thick portion 12b1 whose width along the second slit opening 32 is wider than the tip portion of the second shaft portion 12b is formed at the root portion of the second shaft portion 12b.

With this configuration, the base end of the intermediate support shaft 12 can be reinforced by thickening the root portion of the first shaft portion 12a and the root portion of the second shaft portion 12b.

In the transfer tool of the present embodiment, the first to third slit openings 31 to 33 extend substantially parallel to the direction of the stress acting on the intermediate gear e2 via the transfer tape T when the transfer tape T is used.

With this configuration, when the transfer tool 1 is used by pressing the head at the tip, stresses are applied to the intermediate gear e2 through the tape T, but the stresses can be received by both the first shaft portion 12a and the second shaft portion 12b.

In the transfer tool of the present embodiment, the rotation transmission means includes a feed gear a2 (feed rotation transmission member) rotatably supported by a feed support shaft 10 and integrally rotatable with the feed reel A, a take-up gear c2 (take-up rotation transmission member) rotatably supported by a take-up support shaft 11 and integrally rotatable with the take-up reel C, and an intermediate gear e2 (intermediate rotation transmission member) rotatably supported by an intermediate support shaft 12 and disposed between the feed gear a2 and the take-up gear c2. The stress relief means N is provided to relieve bending stress when the intermediate gear e2 is attached to at least the intermediate support shaft 12 having a smallest shaft diameter among the feed support shaft 10, the take-up support shaft 11, and the intermediate support shaft 12.

With this configuration, it is possible to prevent the intermediate support shaft 12 having the smallest shaft diameter among the feed support shaft 10, the take-up support shaft 11, and the intermediate support shaft 12 from breaking during production and assembly.

An embodiment of the present invention has been described above. However, the configuration of each part is not limited to those in the embodiment described above.

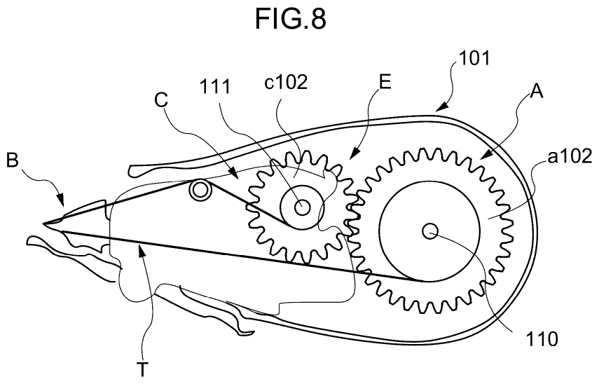

For example, in the above-described embodiment, the reel interlocking mechanism E includes the intermediate gear e2 meshing with the feed gear a2 and the take-up gear c2 between the feed gear a2 and the take-up gear c2, but the invention is not limited thereto. For example, as illustrated in FIG. 8, the reel interlocking mechanism E of the transfer tool 101 may include a disc-shaped feed gear a102 (feed rotation transmission member) rotatably supported by a feed support shaft 110 and integrally rotatable with the feed reel A, and a disc-shaped take-up gear c102 (take-up rotation transmission member) rotatably supported by a take-up support shaft 111 and integrally rotatable with the take-up reel C, and the feed gear a102 and the take-up gear c102 may mesh with each other. In this case, at least one of the feed gear a102 and the take-up gear c102 may be provided with a stress relief means that relieves bending stresses when the gear is attached to the support shaft.

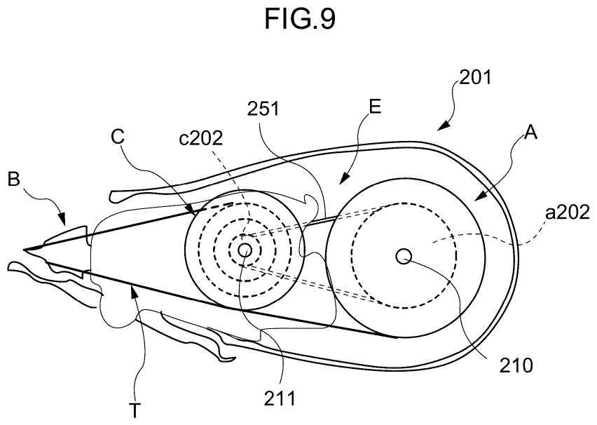

In the above-described embodiment, the reel interlocking mechanism E includes the feed gear a2, the take-up gear c2, and the intermediate gear e2, but the invention is not limited thereto. For example, as illustrated in FIG. 9, the reel interlocking mechanism E of the transfer tool 201 may have a disc-shaped feed pulley a202 rotatably supported by a feed support shaft 210 and integrally rotatable with the feed reel A, a disc-shaped take-up pulley c202 rotatably supported by a take-up support shaft 211 and integrally rotatable with the take-up reel C, and a belt 251 bridged between the feed pulley a202 and the take-up pulley c202. In this case, at least one of the feed pulley a202 and the take-up pulley c202 may be provided with a stress relief means that relieves bending stresses when the pulley is attached to the support shaft.

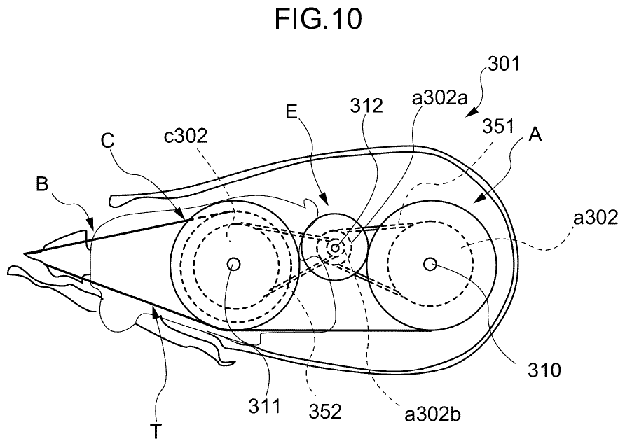

Further, for example, as illustrated in FIG. 10, the reel interlocking mechanism E of a transfer tool 301 may include a disc-shaped feed pulley a302 (feed rotation transmission member) rotatably supported by a feed support shaft 310 and integrally rotatable with the feed reel A, a disc-shaped take-up pulley c302 (take-up rotation transmission member) rotatably supported by a take-up support shaft 311 and integrally rotatable with the take-up reel C, disc-shaped intermediate pulleys e302a, e302b (intermediate rotation transmission members) rotatably supported by an intermediate support shaft 312 and disposed between the feed pulley a302 and the take-up pulley c302, a belt 351 bridged between the feed pulley a302 and the intermediate pulley e302a, and a belt 352 bridged between the take-up pulley c202 and the intermediate pulley e302b. In this case, at least one of the feed pulley a302, the take-up pulley c302, and the intermediate pulleys e302a, e302b may be provided with a stress relief means that relieves bending stresses when the pulley is attached to the support shaft.

In the above-described embodiment, the stress relief means N is provided so as to relieve the bending stress when the intermediate gear e2 is attached to the intermediate support shaft 12 having the smallest shaft diameter among the feed support shaft 10, the take-up support shaft 11, and the intermediate support shaft 12, but the present invention is not limited thereto. The stress relief means N may be provided so as to relieve the bending stress when a gear is attached to at least one of the feed support shaft 10, the take-up support shaft 11 and the intermediate support shaft 12. Therefore, the stress relief means N may be formed in the vicinity of the lower end portion of the feed support shaft 10 that rotatably supports the feed gear a2, or may be formed in the vicinity of the lower end portion of the take-up support shaft 11 that rotatably supports the take-up gear c2. In the above-described embodiment, the first to third slit openings 31 to 33 are formed as the stress relief means N, but the present invention is not limited thereto. The configuration of the stress relief means N is not limited to the first to third slit openings 31 to 33, and may be any configuration as long as the bending stress is dispersed and does not concentrate on the root portion of the support shaft when the gear is attached.

Even when the first to third slit openings 31 to 33 are formed as the stress relief means N, the first to third slit openings 31 to 33 may extend in any direction.

In the above-described embodiment, the intermediate support shaft 12 to which the intermediate gear e2 is attached is divided into the first shaft portion 12a and the second shaft portion 12b, but the present invention is not limited thereto. The number of divisions of the support shaft to which the gear is attached and the shape of the divided shaft portion are freely selected.

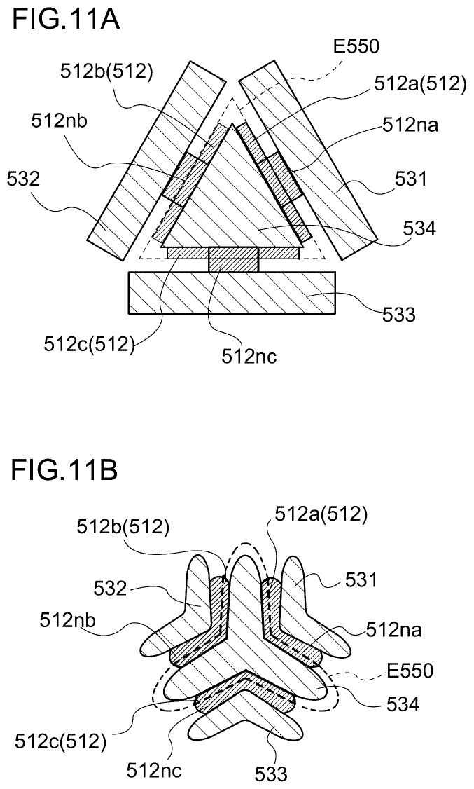

For example, as illustrated in FIGS. 11(a) and 11(b), the support shaft to which the gear is attached may be divided into three.

In FIG. 11(a), a support shaft 512 has three first to third shaft portions 512a to 512c divided in the circumferential direction, and first to fourth openings 531 to 534 are formed in the vicinity of the root portion of the support shaft 512. A first shaft portion 512a is disposed between the first opening 531 and the fourth opening 534, a second shaft portion 512b is disposed between the second opening 532 and the fourth opening 534, and a third shaft portion 512c is disposed between the third opening 533 and the fourth opening 534. Locking portions 512na to 512nc that are locked to the upper surface of the intermediate gear e2 when the intermediate gear e2 is attached are formed to protrude on the outer sides of the tip portions of the first to third shaft portions 512a to 512c. The protrusion amount of the locking portions 512na to 512nc increases from the tip to the root of the locking portions 512na to 512nc.

In this case, when the intermediate gear e2 is attached to the intermediate support shaft 512, the intermediate gear e2 is moved toward the root portion of the intermediate support shaft 512 in such a manner that the first to third shaft portions 512a to 512c of the intermediate support shaft 512 are inserted into a triangular shaft hole e550 of the intermediate gear e2 (in FIG. 11(a), the shape and size of the shaft hole e550 are indicated by dotted lines). Then, the locking portions 512na to 512nc of the first to third shaft portions 512a to 512c are pressed by the inner peripheral surface of the shaft hole e550 of the intermediate gear e2, and the tip portions of the first to third shaft portions 512a to 512c move so as to approach each other. At this time, the root portions of the first to third shaft portions 512a to 512c also move so as to approach one another. Thereafter, when the tip portions of the first to third shaft portions 512a to 512c move so as to be separated from each other and return to their original positions, the upper surface of the intermediate gear e2 is locked by the locking portions 512na to 512nc of the first to third shaft portions 512a to 512c, and the attachment of the intermediate gear e2 to the support shaft 512 is completed.

FIG. 11(b) illustrates an example in which the shapes of the first to third shaft portions 512a to 512c, the locking portions 512na to 512nc, and the first to fourth openings 531 to 534 are different from those of FIG. 11(a). In the case of FIG. 11(b), the shaft hole e550 of the intermediate gear e2 has a shape substantially similar to that of the fourth opening 534, and the shape and size of the shaft hole e50 are indicated by dotted lines.

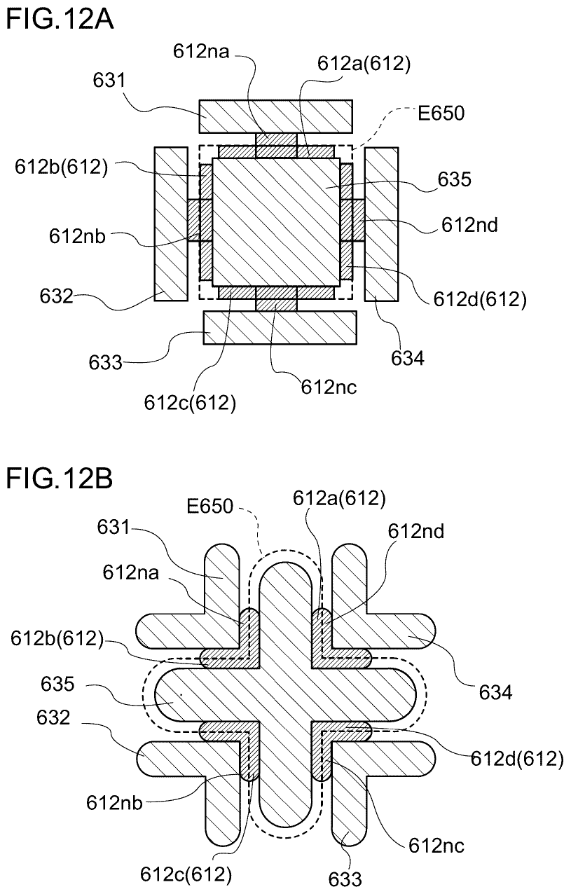

Further, as illustrated in FIGS. 12(a) and 12(b), the support shaft to which the gear is attached may be divided into four.

In FIG. 12(a), a support shaft 612 has four first to fourth shaft portions 612a to 612d divided in the circumferential direction, and first to fifth openings 631 to 635 are formed in the vicinity of the root portion of the support shaft 612. The first shaft portion 612a is disposed between the first opening 631 and the fifth opening 635, the second shaft portion 612b is disposed between the second opening 632 and the fifth opening 635, the third shaft portion 612c is disposed between the third opening 633 and the fifth opening 635, and the fourth shaft portion 612d is disposed between the fourth opening 634 and the fifth opening 635. Locking portions 612na to 612nd that are locked to the upper surface of the intermediate gear e2 when the intermediate gear e2 is attached are formed to protrude on the outer sides of the tip portions of the first to third shaft portions 612a to 612d. The protrusion amount of the locking portions 612na to 612nd increases from the tip to the root of the locking portions 612na to 612nd.

In this case, when the intermediate gear e2 is attached to the intermediate support shaft 612, the intermediate gear e2 is moved toward the root portion of the intermediate support shaft 612 in such a manner that the first to fourth shaft portions 612a to 612d of the intermediate support shaft 612 are inserted into a quadrangular shaft hole e650 of the intermediate gear e2 (in FIG. 12(a), the shape and size of the shaft hole e650 are indicated by dotted lines). Then, the locking portions 612na to 612nd of the first to fourth shaft portions 612a to 612d are pressed by the inner peripheral surface of the shaft hole e650 of the intermediate gear e2, and the tip portions of the first to fourth shaft portions 612a to 612d move so as to approach each other. At this time, the root portions of the first to fourth shaft portions 612a to 612d also move so as to approach one another. Thereafter, when the tip portions of the first to fourth shaft portions 612a to 612d move so as to be separated from each other and return to their original positions, the upper surface of the intermediate gear e2 is locked by the locking portions 612na to 612nd of the first to fourth shaft portions 612a to 612d, and the attachment of the intermediate gear e2 to the support shaft 612 is completed.

FIG. 12(b) illustrates an example in which the shapes of the first to fourth shaft portions 612a to 612d, the locking portions 612na to 612nd, and the first to fifth openings 631 to 635 are different from those of FIG. 12(a). In the case of FIG. 12(b), the shaft hole e650 of the intermediate gear e2 has a shape substantially similar to that of the fifth opening 635, and the shape and size of the shaft hole e650 are indicated by dotted lines.

In the above-described embodiment, the transfer tool may be any transfer tool as long as the transfer tool transfers the transfer object to the transfer target. In other words, the transfer object is not limited to the correction tape material (thin film-like correction material) illustrated in the present embodiment, and may be, for example, a tape paste or a decorative material (decorative tape) for decoration.

In the above-described embodiment, the transfer tool may be of a so-called disposable type which cannot be used thereafter when the transfer tape runs out, or may be of a so-called refill replacement type in which a refill holding the transfer tape can be replaced in the case.

In the above-described embodiment, the number of the intermediate gears e2 constituting the reel interlocking mechanism E is not limited to one, but may be two or more. The reel interlocking mechanism E may have any configuration as long as it transmits the rotation of the feed reel A to the take-up reel C.

Other configurations can also be modified in various ways without departing from the gist of the present invention.

### INDUSTRIAL APPLICABILITY

The present invention can be used as, for example, a transfer tool for transferring a transfer object to a transfer target surface.

### REFERENCE SIGNS LIST

1 transfer tool
A feed reel
B transfer head
C take-up reel
E reel interlocking mechanism (rotation transmission means)
10 feed support shaft
11 take-up support shaft
12 intermediate support shaft
12a first shaft portion
12a1 first thick portion
12b second shaft portion
12b1 second thick portion
a2 feed gear (rotation transmission member)
c2 take-up gear (rotation transmission member)
e2 intermediate gear (rotation transmission member)
31 first slit opening
32 second slit opening
33 third slit opening
51 first support portion
52 second support portion
101 transfer tool
110 feed support shaft
111 take-up support shaft
112 intermediate support shaft
a102 feed gear (rotation transmission member)
c102 take-up gear (rotation transmission member)
201 transfer tool
210 feed support shaft
211 take-up support shaft
a202 feed pulley (rotation transmission member)
c202 take-up pulley (rotation transmission member)
251 belt
301 transfer tool
310 feed support shaft
311 take-up support shaft
312 intermediate support shaft
a302 feed pulley (rotation transmission member)
c302 take-up pulley (rotation transmission member)
e302a intermediate pulley (rotation transmission member)
e302b intermediate pulley (rotation transmission member)
351, 352 belt
T transfer tape
N stress relief means

1. A transfer tool that allows a transfer tape fed out from a feed reel to be wound onto a take-up reel via a transfer head, the transfer tool comprising a rotation transmission means having a plurality of rotation transmission members that have a disc shape and transmitting rotation of the feed reel to the take-up reel,
wherein each rotation transmission member is rotatably supported by a support shaft, and
wherein at least one rotation transmission member of the plurality of rotation transmission members is provided with a stress relief means that relieves bending stress when the rotation transmission member is attached to the support shaft.

2. The transfer tool according to claim 1,
wherein the support shaft has a plurality of shaft portions divided in a circumferential direction, and
wherein the stress relief means includes an opening provided inside the plurality of shaft portions.

3. The transfer tool according to claim 2,
wherein the stress relief means includes a first slit opening, a second slit opening, and a third slit opening,
wherein the support shaft has a first shaft portion and a second shaft portion divided in a circumferential direction,
wherein the first shaft portion is provided in a first support portion disposed between the first slit opening and the second slit opening, and
wherein the second shaft portion is provided in a second support portion disposed between the second slit opening and the third slit opening.

4. The transfer tool according to claim 3,
wherein a first thick portion whose width along the second slit opening is wider than a tip portion of the first shaft portion is formed at a root portion of the first shaft portion, and
wherein a second thick portion whose width along the second slit opening is wider than a tip portion of the second shaft portion is formed at a root portion of the second shaft portion.

5-8. (canceled)

9. The transfer tool according to claim 3, wherein the first to third slit openings extend substantially parallel to a direction of stress acting on the rotation transmission member via the transfer tape when the transfer tape is used.

10. The transfer tool according to claim 4, wherein the first to third slit openings extend substantially parallel to a direction of stress acting on the rotation transmission member via the transfer tape when the transfer tape is used.

11. The transfer tool according to claim 1, the rotation transmission means comprising:
a feed rotation transmission member rotatably supported by a feed support shaft and integrally rotatable with the feed reel;
a take-up rotation transmission member rotatably supported by a take-up support shaft and integrally rotatable with the take-up reel; and
an intermediate rotation transmission member rotatably supported by an intermediate support shaft and disposed between the feed rotation transmission member and the take-up rotation transmission member,
wherein the stress relief means is provided to relieve bending stress when the rotation transmission member is attached to at least a support shaft having a smallest shaft diameter among the feed support shaft, the take-up support shaft, and the intermediate support shaft.

12. The transfer tool according to claim 2, the rotation transmission means comprising:
a feed rotation transmission member rotatably supported by a feed support shaft and integrally rotatable with the feed reel;
a take-up rotation transmission member rotatably supported by a take-up support shaft and integrally rotatable with the take-up reel; and
an intermediate rotation transmission member rotatably supported by an intermediate support shaft and disposed between the feed rotation transmission member and the take-up rotation transmission member,
wherein the stress relief means is provided to relieve bending stress when the rotation transmission member is attached to at least a support shaft having a smallest shaft diameter among the feed support shaft, the take-up support shaft, and the intermediate support shaft.

13. The transfer tool according to claim 3, the rotation transmission means comprising:
a feed rotation transmission member rotatably supported by a feed support shaft and integrally rotatable with the feed reel;
a take-up rotation transmission member rotatably supported by a take-up support shaft and integrally rotatable with the take-up reel; and
an intermediate rotation transmission member rotatably supported by an intermediate support shaft and disposed between the feed rotation transmission member and the take-up rotation transmission member,
wherein the stress relief means is provided to relieve bending stress when the rotation transmission member is attached to at least a support shaft having a smallest shaft diameter among the feed support shaft, the take-up support shaft, and the intermediate support shaft.

14. The transfer tool according to claim 4, the rotation transmission means comprising:
a feed rotation transmission member rotatably supported by a feed support shaft and integrally rotatable with the feed reel;
a take-up rotation transmission member rotatably supported by a take-up support shaft and integrally rotatable with the take-up reel; and
an intermediate rotation transmission member rotatably supported by an intermediate support shaft and disposed between the feed rotation transmission member and the take-up rotation transmission member,
wherein the stress relief means is provided to relieve bending stress when the rotation transmission member is attached to at least a support shaft having a smallest shaft diameter among the feed support shaft, the take-up support shaft, and the intermediate support shaft.

15. The transfer tool according to claim 1, the rotation transmission member is a gear.

16. The transfer tool according to claim 2, the rotation transmission member is a gear.

17. The transfer tool according to claim 3, the rotation transmission member is a gear.

18. The transfer tool according to claim 4, the rotation transmission member is a gear.

19. The transfer tool according to claim 1, the rotation transmission member is a pulley.

20. The transfer tool according to claim 2, the rotation transmission member is a pulley.

21. The transfer tool according to claim 3, the rotation transmission member is a pulley.

22. The transfer tool according to claim 4, the rotation transmission member is a pulley.
